(19) United States
(12) Patent Application Publication
(10) Pub. No.: US 2019/0104195 A1
(43) Pub. Date: Apr. 4, 2019

(54) COMPUTER SYSTEM AND METHOD FOR CONTROLLING COMMUNICATION PATH

(71) Applicant: HITACHI, LTD., Tokyo (JP)

(72) Inventors: Taisuke FUKUYAMA, Tokyo (JP); Shuuhei MATSUMOTO, Tokyo (JP); Kyosuke ACHIWA, Tokyo (JP); Toru MAEDA, Tokyo (JP); Hiroto EBARA, Tokyo (JP)

(73) Assignee: HITACHI, LTD., Tokyo (JP)

(21) Appl. No.: 16/128,050

(22) Filed: Sep. 11, 2018

(30) Foreign Application Priority Data
Oct. 3, 2017 (JP) 2017-193672

(51) Int. Cl. H04L 29/08; H04L 29/06

(52) U.S. Cl. CPC H04L 67/2814; H04L 69/14; H04L 67/1097; H04L 63/08; H04L 67/1002; H04L 67/32

(57) ABSTRACT

A computer system comprises a first computer having a first processing performed processing by using a storage region; a second computer having a second processing unit provided the storage region, manage a first port for communication with the first processing unit, and execute a processing request to the storage region; and a third computer having a third processing unit manage a second port for communication with the first processing unit. The third processing unit holds port management information for managing a correspondence relationship of the first port and the second port, selects the first port for redirecting on the basis of the port management information in a case of receiving a connection request; and transmits a response notifying the first port for redirecting to the first processing unit.

### CLAIM OF PRIORITY

The present application claims priority from Japanese patent application JP 2017-193672 filed on Oct. 3, 2017, the content of which is hereby incorporated by reference into this application.

### BACKGROUND OF THE INVENTION

The present invention relates to a system for controlling a communication path between a server that provides a storage region and a client that uses the storage region, and a control method of the communication path.

A log-in redirection function is implemented in an iSCSI protocol. For example, Japanese Patent Application Publication No. 2005-165477 discloses this function.

Japanese Patent Application Publication No. 2005-165477 discloses as “When a redirection instruction device is newly provided and a client device accesses a disk device, the client device first transmits a log-in request packet to the redirection instruction device. The redirection instruction device selects the disk device that is an access destination on the basis of storage information of a disk device selection information management table, and transmits the log-in response packet for redirection instruction. The client device transmits the log-in request packet again to the disk device that is instructed by the log-in response packet for the redirection instruction”.

When the log-in redirection function is used, it is not necessary for an iSCSI initiator to manage a network portal of an iSCSI target. Thus, a configuration of the iSCSI target can be flexibly changed. In addition, when a technique disclosed in Japanese Patent Application Publication No. 2005-165477 is used, concentration of loads to a specific storage device (iSCSI target) can be prevented, and failure of the client device (iSCSI initiator) can be prevented in advance.

In a system connecting a client such as the iSCSI and a server, a multipath is utilized for the purpose of increasing load dispersion and failure-tolerance. For example, Japanese Patent Application Publication No. 2006-323729 discloses this technique. Specifically, a plurality of logical communication paths connecting an iSCSI initiator and an iSCSI target are established.

### SUMMARY OF THE INVENTION

In a case where different paths are established by utilizing a log-in redirection function, it is necessary that a node that performs redirection notifies an iSCSI initiator, of network portals of different iSCSI targets.

However, an initial node does not recognize network portals of iSCSI targets that have been notified in past, and does not manage correspondence relationships between the paths and the iSCSI targets. Thus, the initial node that performs redirection cannot notify the iSCSI initiator, of network portal information of the different iSCSI targets. That is, a multipath for the purpose of load dispersion, avoiding of failure, and the like cannot be realized even if utilizing the log-in redirection function as it is.

An object of the present invention is to provide a system and a method for utilizing a log-in redirection function to establish a plurality of paths.

The present invention can be appreciated by the description which follows in conjunction with the following figures, wherein: a computer system comprises a plurality of computers. The plurality of computers has at least one arithmetic device, at least one storage device coupled to the at least one arithmetic device, and a plurality of communication devices coupled to the at least one arithmetic device. The plurality of computers includes: a first computer having a first processing unit configured to perform processing by using a storage region; a second computer having a second processing unit configured to provide the storage region, manage a first port for communication with the first processing unit, and execute a processing request to the storage region that has been received via the first port; and a third computer having a third processing unit configured to manage a second port for communication with the first processing unit, and notify the first computer of the first port for redirecting serving as a redirect destination of a connection request for establishment of a communication path connecting the first processing unit and the second processing unit in a case of receiving the connection request via the second port. The first processing unit is configured to: transmit the connection request to the second port in a case of establishing the communication path; receive a response notifying the first port for redirecting from the third processing unit; and transmit the connection request to the first port for redirecting to establish the communication path. The third processing unit is configured to: select the first port for redirecting on the basis of the port management information in a case of receiving the connection request; and transmit the response notifying the first port for redirecting to the first processing unit.

According to the present invention, a plurality of paths (communication paths) can be established by utilizing the log-in redirection function. Problems, configurations, and effects other than those described above are clarified by description of embodiments below.

### BRIEF DESCRIPTION OF THE DRAWINGS

The present invention can be appreciated by the description which follows in conjunction with the following figures, wherein:

FIG. 1 is a diagram showing a configuration example of a computer system that realizes connection using an iSCSI protocol of a first embodiment;

FIG. 2 is a diagram showing a hardware configuration of a computer including the computer system of the first embodiment;

FIG. 3 is a diagram showing an example of a data structure of target connection information of the first embodiment;

FIG. 4 is a diagram showing an example of a data structure of target portal management information of the first embodiment;

FIG. 5 is a flowchart for explaining an example of generation processing of target portal management information performed by an initial node of the first embodiment;

FIG. 6 is a flowchart for explaining an example of target portal allocation processing performed by the initial node of the first embodiment.

FIG. 7 is a sequence diagram for explaining a flow of log-in processing in the computer system of the first embodiment;

FIG. 8 is a flowchart for explaining an example of processing performed by the initial node of the first embodiment in a case of receiving a log-in request;

FIG. 9 is a flowchart for explaining an example of target portal addition processing performed by the initial node of the first embodiment;

FIG. 10 is a flowchart for explaining an example of target portal deletion processing performed by a target node of the first embodiment;

FIG. 11 is a flowchart for explaining an example of target portal deletion processing performed by the initial node of the first embodiment

FIG. 12 is a flowchart for explaining an example of failure processing performed by the initial node of the first embodiment;

FIG. 13 is a flowchart for explaining an example of restoration processing performed by the initial node of the first embodiment;

FIG. 14 and FIG. 15 are diagrams for explaining effects of the first embodiment;

FIG. 16A and FIG. 16B are sequence diagrams for explaining a flow of processing in a case where communication failure of a path occurs in the computer system of a second embodiment;

FIG. 17 is a diagram showing a configuration example of the computer system that realizes the connection using the iSCSI protocol of a third embodiment;

FIG. 18 is a diagram showing an example of the data structure of initial connection information of the third embodiment;

FIG. 19 is a flowchart for explaining an example of processing performed by the initial node of the third embodiment in a case of receiving the log-in request; and

FIG. 20 and FIG. 21 are diagrams for explaining problems of conventional techniques.

### DETAILED DESCRIPTION OF THE EMBODIMENTS

Now, a description is given of an embodiment of this invention referring to the drawings. It should be noted that this invention is not to be construed by limiting the invention to the content described in the following embodiment. A person skilled in the art would easily recognize that a specific configuration described in the following embodiment may be changed within the scope of the concept and the gist of this invention.

In a configuration of this invention described below, the same or similar components or functions are assigned with the same reference numerals, and a redundant description thereof is omitted here.

Notations of, for example, “first”, “second”, and “third” herein are assigned to distinguish between components, and do not necessarily limit the number or order of those components.

The position, size, shape, range, and others of each component illustrated in, for example, the drawings may not represent the actual position, size, shape, range, and other metrics in order to facilitate understanding of this invention. Thus, this invention is not limited to the position, size, shape, range, and others described in, for example, the drawings.

Here, terms used herein are defined.

An “initiator” refers to a client (device) in an SCSI protocol. A “target” refers to a server (logical unit) in the SCSI protocol. Note that the target is sometimes described so as to include the logical unit and include a function of processing a request of the initiator.

An initiator issues a command corresponding to a writing request or reding request with respect to a target, and transmits data to be written to the target. The target receives the command, performs processing corresponding to the command, and responds with a result of processing or the like to the initiator.

An “initiator node” refers to a node serving as an initiator in an iSCSI protocol. The “target node” refers to a node serving as a target in the iSCSI protocol. Hereinafter, when the initiator node and the target node are not distinguished from each other, they are referred to as iSCSI node.

A “network entity” refers to a device and a gateway that can be accessed from an IP network. A “network portal” refers to a component of the network entity having a TCP/IP network address and used for establishing the iSCSI session by the iSCSI node. The network portal is specified with a set of an IP address and a TCP port number, and functions as a logical port for communicating with the iSCSI node. Herein, the set of the IP address and the TCP port number for specifying the network portal is also referred to as “network information”. The iSCSI nodes communicate with each other via the network portal.

### First Embodiment

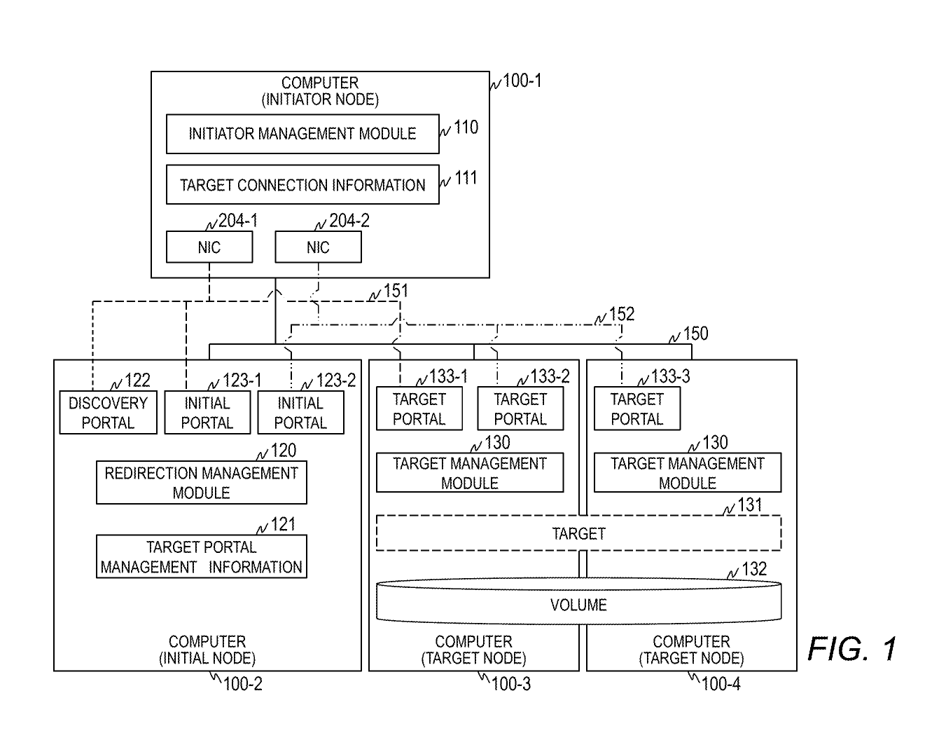

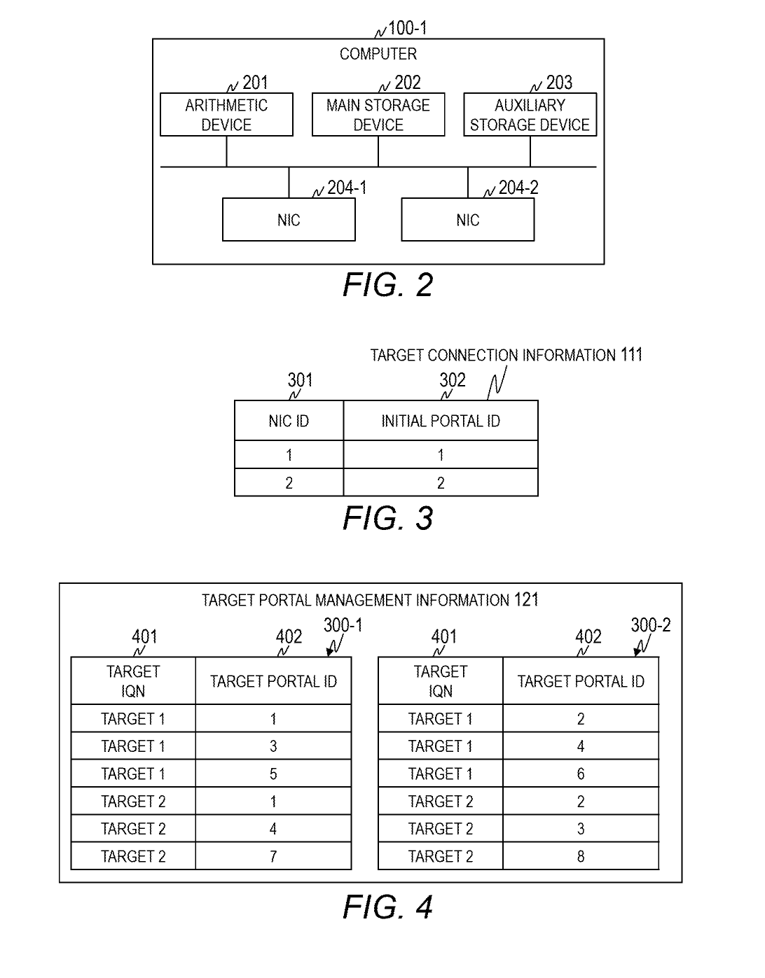

FIG. 1 is a diagram showing a configuration example of a computer system that realizes connection using an iSCSI protocol of a first embodiment. FIG. 2 is a diagram showing a hardware configuration of a computer including the computer system of the first embodiment.

The computer system is composed of four computers 100-1, 100-2, 100-3, 100-4. The four computers 100-1, 100-2, 100-3, 100-4 are connected with each other via a network 150 such as a local area network (LAN).

Hereinafter, each of the computers is referred to as a computer 100 when the computers 100-1, 100-2, 100-3, 100-4 are not distinguished from each other.

Note that the number of the computer 100 included in the computer system may be three or less, or more than four.

The computer 100 includes an arithmetic device 201, a main storage device 202, an auxiliary storage device 203, and a plurality of NIC 204-1, NIC 204-2. Hereinafter, each of the NICs is referred to as an NIC 204 when the NIC 204-1 and the NIC 204-2 are not distinguished from each other. Note that the number of the arithmetic device 201, the main storage device 202, and the auxiliary storage device 203 may be two or more. The number of the NIC 204 of the computer 100-1 may be three or more. The number of the NIC 204 of the computers 100-2, 100-3, 100-4 may be one, or three or more.

The arithmetic device 201 is a device that executes a program stored in the main storage device 202, and is, for example, a processor, a graphics processing unit (GPU), and the like. The arithmetic device 201 performs processing in accordance with the program to operate as a module that realizes a specific function. Hereinafter, when processing is described with the module as the subject, description indicates that the arithmetic device 201 executes a program realizing the module.

The main storage device 202 is a device that stores a program to be executed by the arithmetic device 201 and data to be used by the program, and is, for example, a non-volatile memory or a volatile memory. The main storage device 202 includes a storage region that is temporarily used by the module.

The auxiliary storage device 203 is a device that stores data permanently, and is, for example, a hard disk drive (HDD), a solid state drive (SSD), and the like.

The NIC 204 is an interface connecting with other devices via a network.

Note that the computer 100 may have an input device such as a keyboard, a mouse, and a touch panel, and an output device such as a display.

The computer 100-1 serves as an initiator node of the iSCSI protocol, the computer 100-2 serves as an initial node having a log-in redirection function in the iSCSI protocol, and the computers 100-3, 100-4 serve as target nodes of the iSCSI protocol.

Here, the log-in redirection function is a function of responding with the network portal of the target node used for establishing a path (communication path). When this function is used, it is not necessary that the initiator node directly manages the network portal of the target node, so that the configuration of the target node can be changed flexibly.

Hereinafter, the computer 100-1 is also referred to as an initiator node 100-1, the computer 100-2 is also referred to as an initial node 100-2, and the computers 100-3, 100-4 are also referred to as target nodes 100-3, 100-4.

The main storage device 202 of the initiator node 100-1 stores a program that realizes an initiator management module 110, and stores target connection information 111. Note that the target connection information 111 may be stored in the auxiliary storage device 203.

The initiator management module 110 has a function of realizing the initiator. An application or an operating system (OS) on the computer 100-1 accesses a target 131 via the initiator management module 110.

The target connection information 111 is information for managing the network portal (initial portal) of the initial node 100-2 that is accessed via the NIC 204 included in the initiator node 100-1. Details of the target connection information 111 will be described with reference to FIG. 3.

The main storage device 202 of the target nodes 100-3, 100-4 stores the program that realizes a target management module 130. The target management module 130 manages a correspondence relationship of the target 131 and a volume 132 that is accessed by the initiator node 100-1.

Target portals 133-1, 133-2 are set in the target node 100-3. A target portal 133-3 is set in the target node 100-4. The target portals 133-1, 133-2, 133-3 refer to network portals used for establishment of a path between the initiator node 100-1 and the target 131.

Hereinafter, each of the target portals is referred to as a target portal 133 when the target portals 133-1, 133-2, 133-3 are not distinguished from each other. The number of the target portal 133 set in the target nodes 100-3, 100-4 can be set to any number.

The main storage device 202 of the initial node 100-2 stores the program realizing the redirection management module 120, and stores the target portal management information 121. Note that the target portal management information 121 may be stored in the auxiliary storage device 203.

A discovery portal 122, and a plurality of initial portals 123-1, 123-2 are set in the initial node 100-2. The discovery portal 122 refers to a network portal used for establishment of a path used for discovering of the target 131. The initial portals 123-1, 123-2 refer to network portals used for establishment of a path for access to the target 131.

Hereinafter, each of the initial portals is referred to as an initial portal 123 when the initial portals 123-1, 123-2 are not distinguished from each other.

In the present embodiment, the plurality of initial portals 123 are set in the initial node 100-2. The number of the initial portal 123 is determined in accordance with the number of path (multiple degree) set in the system. As a method of setting the plurality of initial portals 123, a method of allocating different IP addresses, or a method of allocating different TCP port numbers are conceived.

Note that the number of the initial portal 123 may be larger than the number of the path to be set. Thereby, addition of the target 131 and the change in the number of the path can be coped with flexibly.

The target portal management information 121 is information for managing the target portal 133 of a redirect destination notified to the initiator node 100-1 when one path is established. More specifically, the target portal management information 121 is information for managing allocation of the target portal 133 to each of the plurality of initial portals 123. Details of the target portal management information 121 will be described with reference to FIG. 4.

Note that, for the modules included in each of the computers 100, a plurality of modules may be collected to one module, or one module may be divided to a plurality of modules for each function.

A solid line 150 of FIG. 1 indicates a physical connection relationship among the computers 100. A broken line 151 indicates logical connection among the computers 100 via the NIC 204-1. A broken line 152 indicates a logical connection relationship among the computers 100 via the NIC 204-2.

In the present embodiment, a case where two paths are established in between the initiator node 100-1 and the target 131 will be described as an example. One path is a path established by using the NIC 204-1 and the target portal 133-1. Another path is a path established by using the NIC 204-2, and the target portal 133-2 or the target portal 133-3.

FIG. 3 is a diagram showing an example of a data structure of the target connection information 111 of the first embodiment.

The target connection information 111 includes an entry formed of an NIC ID 301 and an initial portal ID 302.

The NIC ID 301 is a field that stores identification information of the NIC 204 included in the initiator node 100-1. For example, the identification number, the IP address, and the like is stored in the NIC ID 301. The initial portal ID 302 is a field that stores identification information of the initial portal 123 that is a transmission destination of a log-in request.

Note that the initiator node 100-1 manages the network information of the initial portal 123 in association with the identification information of the initial portal 123.

In the present embodiment, as shown in FIG. 3, one initial portal 123 is allocated to one NIC 204 without duplicating.

FIG. 4 is a diagram showing an example of a data structure of the target portal management information 121 of the first embodiment.

The target portal management information 121 holds correspondence tables 300-1, 300-2 corresponding to the initial portals 123-1, 123-2, respectively. The correspondence table 300-1 is a table for managing the target portal 133 allocated to the initial portal 123-1, and the correspondence table 300-2 is a table for managing the target portal 133 allocated to the initial portal 123-2. Hereinafter, each of the correspondence tables is referred to as a correspondence table 300 when the correspondence tables 300-1, 300-2 are not distinguished from each other.

The correspondence table 300 includes an entry formed of a target IQN 401 and a target portal ID 402.

The target IQN 401 is a field storing an iSCSI qualified name (IQN) that is identification information of the target 131. The target portal ID 402 is a field storing identification information of the target portal 133 used when the target 131 corresponding to the target IQN 401 is accessed.

Note that the initial node 100-2 manages the network information of the target portal 133 in association with the identification information of the target portal 133.

In the present embodiment, the redirection management module 120 allocates the target portal 133 to each of the initial portals 123 such that the target portals 133 of the redirect destination notified to the initiator node 100-1 do not duplicate with each other. Hereinafter, the target portal 133 of the redirect destination is also referred to as a target portal for redirection 133.

Note that, in a case where the targets 131 are different, the target portals 133 to be allocated to the initial portals 123 may duplicate with each other. That is, there may be entries having different values of the target IQN 401 and the same value of the target portal ID 402.

In the target portal management information 121 of FIG. 4, one correspondence table 300 is included in one initial portal 123. However, the target portal management information 121 may include a correspondence table for managing all initial portals 123. The entry included in the correspondence table is formed of, for example, the identification information of the initial portal 123, the identification information of the target 131, and the identification information of the target portal 133.

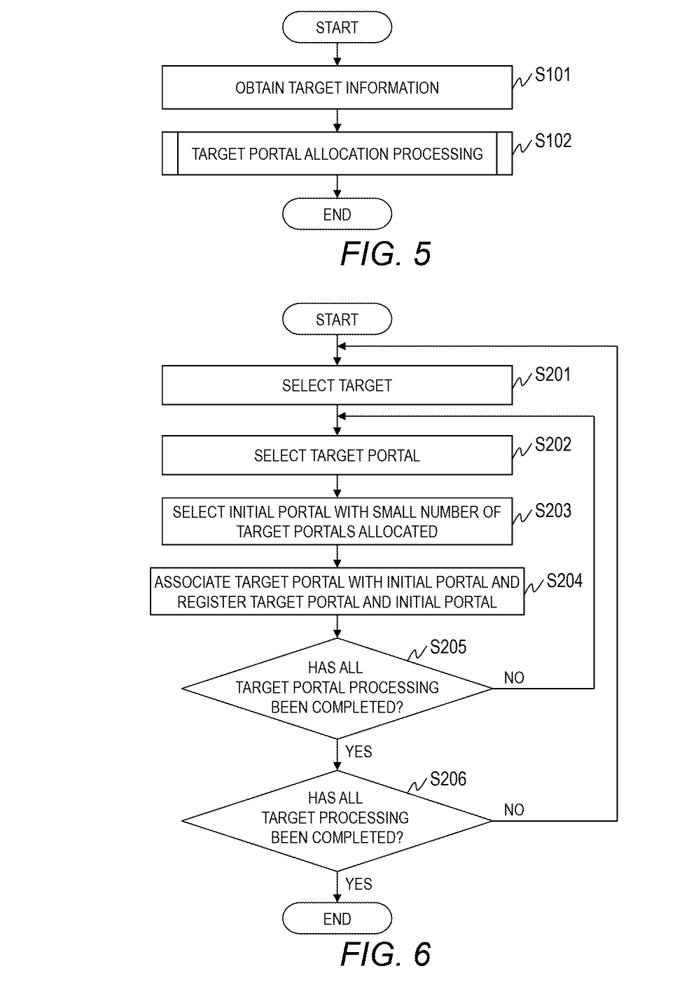

FIG. 5 is a flowchart for explaining an example of generation processing of the target portal management information 121 performed by the initial node 100-2 of the first embodiment.

The redirection management module 120 performs processing described below after the initial node 100-2 starts and a predetermined number of initial portals 123 are set. For example, the processing may be performed immediately after the setting of the initial portal 123, or the processing may be performed in a case where the log-in request is received from the initiator node 100-1.

The redirection management module 120 obtains target information from the target nodes 100-3, 100-4 (step S101). The target information includes the IQN of the target 131, the identification information of the target portal 133, the network information of the target portal 133, and the like.

At this time, the redirection management module 120 stores the target information in the main storage device 202 or the auxiliary storage device 203, and generates a list of the targets 131 and a list of the target portals 133 on the basis of the obtained target information. Note that the list of the targets 131 is a list formed of the IQNs, and the list of the target portals 133 is a list formed of identification information of the target portal 133.

Note that, as a method of obtaining the target information, the following two are conceived, for example.

One method is a method of registering the target information in a storage region of an inside or outside by the target nodes 100-3, 100-4, and obtaining the target information from the storage region via the initial portal 123 by the redirection management module 120.

Another method is a method of inquiring for the target information to the target nodes 100-3, 100-4 via the initial portal 123, by the redirection management module 120. When this method is adopted, the target information is shared between the target nodes 100-3, 100-4 in advance by using a management program for distribution system or the like.

After the target information is obtained, the redirection management module 120 performs target portal allocation processing for allocating the target portal 133 to the initial portal 123 on the basis of the obtained target information (step S102). Details of the target portal allocation processing will be described with reference to FIG. 6.

The redirection management module 120 ends the generation processing of the target portal management information 121 after the target portal allocation processing is completed.

FIG. 6 is a flowchart for explaining an example of the target portal allocation processing performed by the initial node 100-2 of the first embodiment.

The redirection management module 120 selects the target 131 from the list of the targets 131 (step S201).

Next, the redirection management module 120 selects the target portal 133 from the list of the target portals 133 (step S202).

Next, the redirection management module 120 refers to the target portal management information 121 to select the initial portal 123 having a small number of allocated target portal 133 (step S203).

For example, in the case of the target portal management information 121 shown in FIG. 4, the redirection management module 120 searches the correspondence table 300 having the smallest number of the entry to select the initial portal 123 corresponding to the correspondence table 300 that has been searched.

Note that, in a case where there is no entry registered in all correspondence tables 300, the redirection management module 120 selects an arbitrary correspondence table 300. In a case where there are a plurality of correspondence tables 300 having the smallest number of the entry, the redirection management module 120 selects an arbitrary correspondence table 300 from among the correspondence tables 300 having the smallest number of the entry.

Next, the redirection management module 120 registers information in which the selected target portal 133 and the selected initial portal 123 are associated with each other in the target portal management information 121 (step S204).

Specifically, the redirection management module 120 adds an entry to the correspondence table 300 corresponding to the selected initial portal 123. The redirection management module 120 sets the IQN of the selected target 131 to the target IQN 401 of the added entry, and sets the identification information of the selected target portal 133 to the target portal ID 402 of the added entry.

Next, the redirection management module 120 determines whether processing of all target portals 133 registered in the list is completed (step S205).

In a case where it is determined that the processing of all target portals 133 registered in the list is not completed, the redirection management module 120 returns to step S202 and performs similar processing.

In a case where it is determined that the processing of all target portals 133 registered in the list is completed, the redirection management module 120 determines whether the processing of all targets 131 registered in the list is completed (step S206).

In a case where it is determined that the processing of all targets 131 registered in the list is not completed, the redirection management module 120 returns to step S201 and performs similar processing.

In a case where it is determined that the processing of all targets 131 registered in the list is completed, the redirection management module 120 ends the target portal allocation processing.

The redirection management module 120 of the present embodiment controls allocation of the target portals 133 such that the numbers of the target portal 133 to be allocated to each of the initial portals 123 are equal.

However, the allocation control of the target portal 133 described above is an example and the present invention is not limited to this. For example, a ratio of the allocation number of the target portal 133 with respect to each of the initial portals 123 may be set and the number of the target portal 133 to be allocated to each of the initial portals 123 may be controlled on the basis of the ratio.

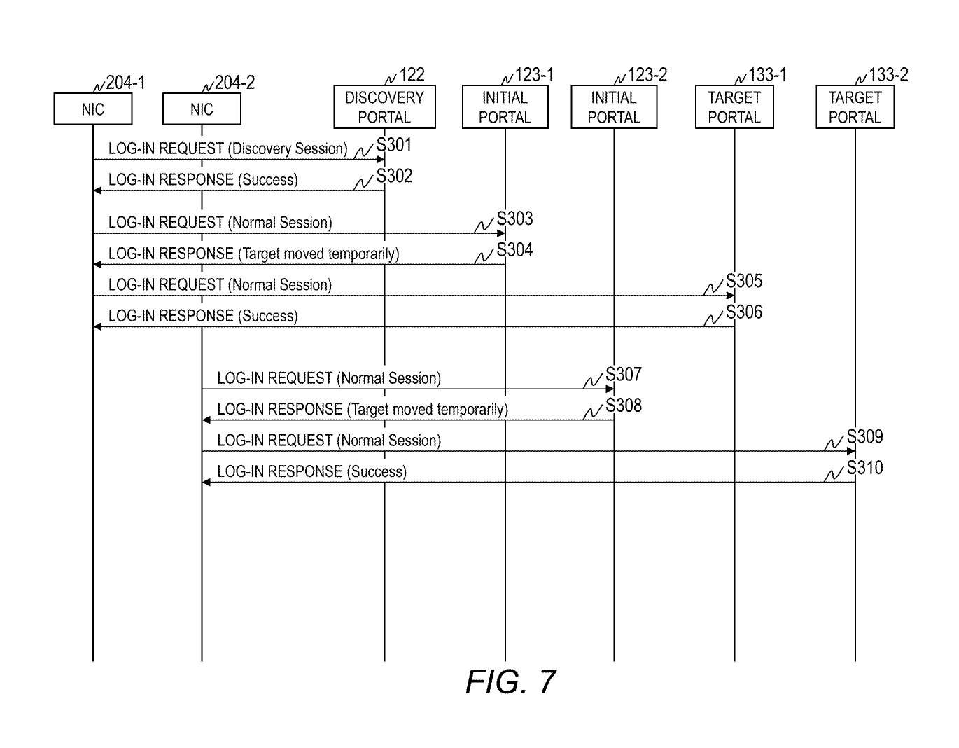

FIG. 7 is a sequence diagram for explaining a flow of log-in processing in the computer system of the first embodiment. The log-in processing is processing for establishing a path in between the initiator node 100-1 and the target 131 by the initiator node 100-1.

Here, it is assumed that the initial node 100-2 holds the target portal management information 121 shown in FIG. 4.

In a case where the log-in to the target 131 is performed for the first time, the initiator node 100-1 establishes a discovery session in between the NIC 204-1 and the discovery portal 122, and transmits a discovery log-in request to the discovery portal 122 (step S301).

In a case of receiving the discovery log-in request via the discovery portal 122, the initial node 100-2 transmits a discovery log-in response including a list of the initial portals 123 to the NIC 204-1 (step S302). The list of the initial portals 123 includes a plurality of entries formed of the identification information and the network information of the initial portal 123.

In a case of receiving the discovery log-in response from the initial node 100-2 via the NIC 204-1, the initiator node 100-1 performs allocation of the initial portal 123 to the NIC 204 and registers the allocation result in the target connection information 111. Specifically, the initiator node 100-1 allocates the initial portals 123-1, 123-2 to each of the NIC 204-1, 204-2 without duplicating, and registers the allocation result in the target connection information 111. It is assumed that the target connection information 111 is in the state shown in FIG. 3.

Next, the initiator node 100-1 refers to the target connection information 111 to transmit a log-in request to the initial portal 123-1 via the NIC 204-1 (step S303).

In a case of receiving the log-in request via the initial portal 123-1, the initial node 100-2 transmits a log-in response notifying of the target portal for redirection 133 to the NIC 204-1 (step S304).

Specifically, the initial node 100-2 selects the target portal for redirection 133-1 on the basis of the target portal management information 121. The initial node 100-2 transmits the log-in response including the identification information of the selected target portal for redirection 133-1 or the like to the NIC 204-1 via the initial portal 123-1.

In a case of receiving the log-in response via the NIC 204-1, the initiator node 100-1 transmits a log-in request to the target portal for redirection 133-1 via the NIC 204-1 (step S305).

In a case of receiving the log-in request via the target portal 133-1, the target node 100-3 transmits a log-in response notifying that the log-in is successful to the NIC 204-1 via the target portal 133-1 (step S306).

A path connecting the NIC 204-1 and the target 131 is established by the processing from step S303 to step S306.

In a case of establishing new path, the initiator node 100-1 refers to the target connection information 111 to transmit a log-in request to the initial portal 123-2 via the NIC 204-2 (step S307).

In a case of receiving the log-in request via the initial portal 123-2, the initial node 100-2 transmits a log-in response notifying of the target portal for redirection 133 to the NIC 204-2 (step S308).

Specifically, the initial node 100-2 selects the target portal for redirection 133-2 on the basis of the target portal management information 121. The initial node 100-2 transmits the log-in response including the identification information of the selected target portal for redirection 133-2 or the like to the NIC 204-2 via the initial portal 123-2.

In a case of receiving the log-in response via the NIC 204-2, the initiator node 100-1 transmits a log-in request to the target portal for redirection 133-2 via the NIC 204-2 (step S309).

In a case of receiving the log-in request via the target portal 133-2, the target node 100-3 transmits a log-in response notifying that the log-in is successful to the NIC 204-2 via the target portal 133-2 (step S310).

A path connecting the NIC 204-2 and the target 131 is established by the processing from step S307 to step S310.

A multipath utilizing the log-in redirection function can be realized by the processing described above.

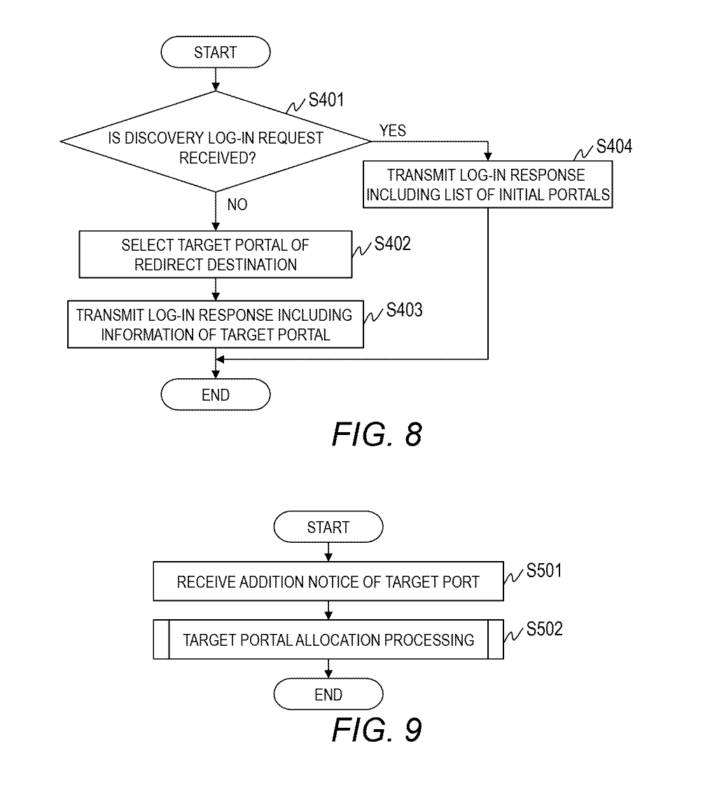

FIG. 8 is a flowchart for explaining an example of processing performed by the initial node 100-2 of the first embodiment in a case of receiving the log-in request.

In a case of receiving a log-in request, the redirection management module 120 determines whether the received log-in request is the discovery log-in request (step S401).

For example, the redirection management module 120 can determine whether the received log-in request is the discovery log-in request on the basis of type information included in the log-in request.

When it is determined that the received log-in request is not the discovery log-in request, the redirection management module 120 selects the target portal for redirection 133 on the basis of the target portal management information 121 (step S402). The log-in request for establishing the path includes the identification information (IQN) of the target 131 of the log-in destination, as well as the identification information (IQN) of the initiator node 100-1 and the identification information of the NIC 204.

In the present embodiment, the redirection management module 120 refers to the correspondence table 300 corresponding to the initial portal 123 that has received the log-in request, and searches an entry with which the identification information of the target 131 of the log-in destination is set in the target IQN 401. Further, the redirection management module 120 selects one entry from among searched entries and obtains the identification information of the target portal for redirection 133 from the target portal ID 402 of the selected entry.

The present invention is not limited to a selection method of the target portal for redirection 133. For example, selection methods of (1) to (4) as below are conceived.

(1) The redirection management module 120 selects the target portal 133 having the smallest number of use as the target portal for redirection 133 for distribution of loads. Here, the number of use indicates the number of notification at the time of establishment of the path of different targets 131. (2) The redirection management module 120 sorts the network information of the searched target portal 133 in predetermined criteria, and selects the target portal for redirection 133 in order of sorts. (3) The redirection management module 120 monitors load of the target portal 133, and selects the target portal 133 having the lowest load as the target portal for redirection 133. (4) A degree of priority indicating the order of selection is set in advance, and the redirection management module 120 selects the target portal for redirection 133 on the basis of the degree of priority.

Next, the redirection management module 120 transmits the log-in response notifying of the selected target portal for redirection 133 to the initiator node 100-1 via the initial portal 123 that has received the log-in request (step S403). Specifically, the log-in response including the identification information of the selected target portal for redirection 133 or the like is transmitted.

In step S401, when it is determined that the received log-in request is the discovery log-in request, the redirection management module 120 transmits the discovery log-in response including the list of the initial portals 123 to the initiator node 100-1 via the discovery portal 122 (step S404).

Next, processing along with addition and deletion of the target portal 133 will be described.

FIG. 9 is a flowchart for explaining an example of target portal addition processing performed by the initial node 100-2 of the first embodiment.

In a case where a new target portal 133 for access to an arbitrary target 131 is added, the target node 100-3 or the target node 100-4 transmits addition notification of the new target portal 133 to the initial portal 123.

The initial node 100-2 receives the addition notification of the new target portal 133 from the target nodes 100-3, 100-4 via the initial portal 123 (step S501).

The initial node 100-2 performs the target portal allocation processing (step S502).

The target portal allocation processing is similar to the processing that has been described with reference to FIG. 6. However, in a case where the target 131 has already been determined, the processing from step S202 to step S205 is performed. In a case where the new target portal 133 is allocated to the initial portal 123 that has received the addition notification of the new target portal 133, only the processing of step S204 is performed.

Note that the allocation of the target portal 133 to all initial portals 123 may be changed as needed, and the correspondence relationship of the target portal 133 and the target 131 with respect to the initial portal 123 to which the new target portal 133 is allocated may be changed. At this time, the initial node 100-2 performs log-out processing with respect to the target portal 133 associated with the path established by using the initial portal 123, and performs the change described above after receiving a completion notification from the target nodes 100-3, 100-4.

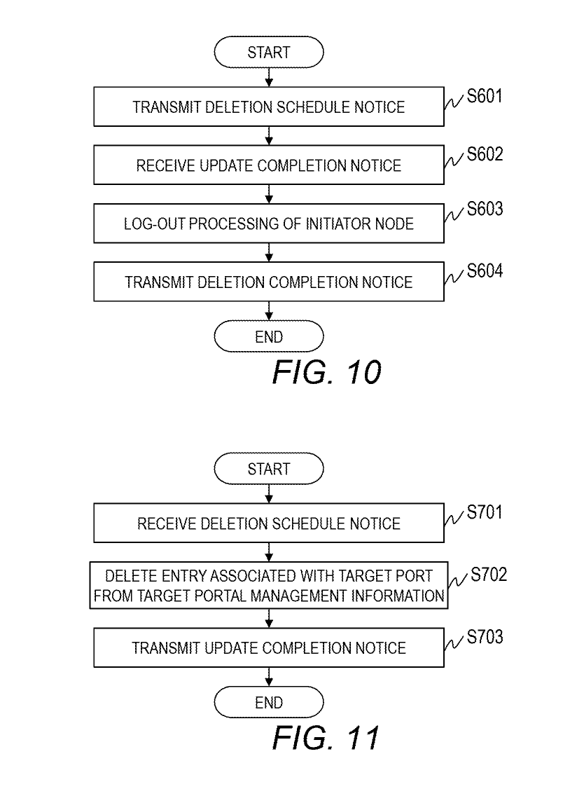

FIG. 10 is a flowchart for explaining an example of target portal deletion processing performed by the target node 100-3 of the first embodiment. FIG. 11 is a flowchart for explaining an example of target portal deletion processing performed by the initial node 100-2 of the first embodiment.

The initial node 100-2 and the target nodes 100-3, 100-4 cooperate to perform the deletion of the target portal 133. Here, a case where the target node 100-3 deletes the target portal 133 for access to an arbitrary target 131 will be described.

First, the processing of the target node 100-3 will be described with reference to FIG. 10.

The target node 100-3 transmits deletion schedule notification of the target portal 133 to the initial portal 123-1 (step S601). Thereafter, the target node 100-3 makes a transition to a waiting state. Note that the deletion schedule notification of the target portal 133 includes identification information of the target portal 133 to be deleted, or the like.

In a case of receiving an update completion notification from the initial node 100-2 (step S602), the target node 100-3 performs the log-out processing of the initiator node 100-1 that is in a log-in state in the target 131 via the target portal 133 to be deleted (step S603).

The target node 100-3 deletes the target portal 133 to be deleted, and transmits a deletion completion notification to the initial portal 123-1 (step S604).

Next, processing of the initial node 100-2 will be described with reference to FIG. 11.

The initial node 100-2 receives the deletion schedule notification of the target portal 133 from the target node 100-3 via the initial portal 123 (step S701).

Next, the initial node 100-2 deletes the entry associated with the target portal 133 to be deleted from the target portal management information 121 (step S702).

In the present embodiment, the initial node 100-2 refers to the correspondence table 300 to search the entry in which the identification information of the target portal 133 to be deleted is stored in the target portal ID 402. The initial node 100-2 deletes the entry searched from the correspondence table 300.

Note that, after deleting the entry from the correspondence table 300, the initial node 100-2 may perform the target portal allocation processing to perform the allocation of the target portal 133 to the initial portal 123 again.

Next, the initial node 100-2 transmits the update completion notification of the target portal management information 121 to the target node 100-3 via the initial portal 123-1 (step S703).

Note that, in a case where the entry is moved among the correspondence tables 300, that is, in a case where the allocation of the target portal 133 is changed, the initial node 100-2 instructs the target portal 133 associated with the path established by using the initial portal 123 in which an entry of a movement source is registered, to perform the log-out processing. After receiving the completion notification of the log-out processing from the target nodes 100-3, 100-4, the initial node 100-2 deletes the entry from the correspondence table 300, and registers the entry in the correspondence table 300 of a movement destination.

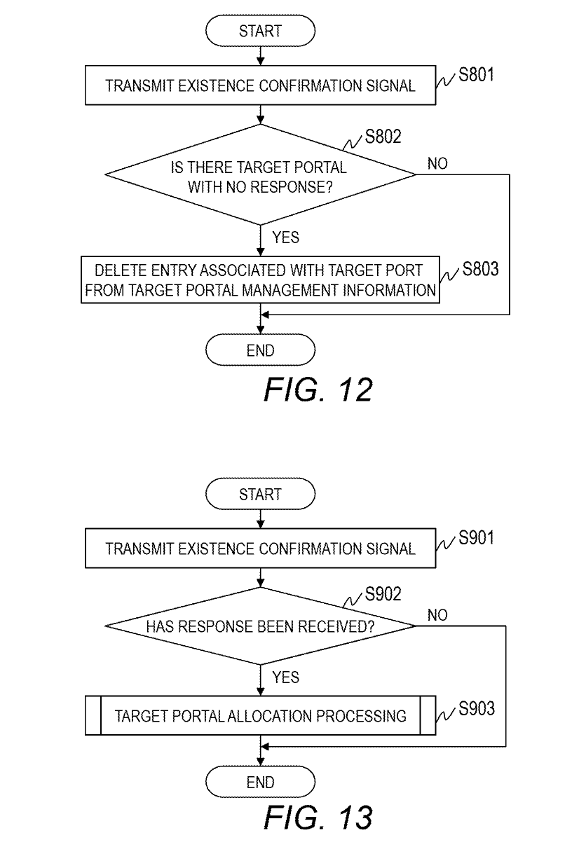

FIG. 12 is a flowchart for explaining an example of failure processing performed by the initial node 100-2 of the first embodiment. FIG. 13 is a flowchart for explaining an example of restoration processing performed by the initial node 100-2 of the first embodiment.

In a case where communication failure of the path along with failure of the target portal 133 occurs, failure processing is performed, and in a case where the failure of the target portal 133 is restored, the restoration processing is performed.

First, the failure processing will be described with reference to FIG. 12. The initial node 100-2 periodically, or in a case of accepting a performing instruction from a user, starts the failure processing.

The initial node 100-2 transmits an existence confirmation signal to the target portals 133-1, 133-2 via each of the initial portals 123-1, 123-2 (step S801).

The initial node 100-2 determines whether the target portal 133 in which failure has occurred exists on the basis of a response corresponding to the existence confirmation signal (step S802).

In a case where it is determined that the target portal 133 in which failure has occurred does not exist, the initial node 100-2 ends the failure processing.

In a case where it is determined that the target portal 133 in which failure has occurred exists, the initial node 100-2 deletes the entry associated with the target portal 133 in which failure has occurred from the target portal management information 121 (step S803). After that, the initial node 100-2 ends the failure processing. The method of deleting the entry from the correspondence table 300 is the same as the method that has been described in step S702.

Note that, after deleting the entry from the correspondence table 300, the initial node 100-2 may perform the allocation of the target portal 133 to the initial portal 123 corresponding to the correspondence table 300 again.

In the present embodiment, presence of failure of the path is determined by using the existence confirmation signal. However, the present invention is not limited thereto. For example, in a system using the Zookeeper that is a management program for a well-known distribution system, a method of periodically confirming presence of an ephemeral node is conceived.

Next, the restoration processing will be described with reference to FIG. 13. In a case of receiving a restoration notification of the target portal 133 from the target nodes 100-3, 100-4 via the initial portal 123-1, the initial node 100-2 starts the restoration processing. Note that the restoration notification includes identification information of the restored target portal 133 or the like.

The initial node 100-2 transmits the existence confirmation signal to the restored target portal 133 via the initial portal 123 (step S901). The initial node 100-2 determines whether the response corresponding to the existence confirmation signal has been received (step S902).

In a case where the initial node 100-2 cannot receive the response to the existence confirmation signal via the initial portal 123, the initial node 100-2 ends the restoration processing.

In a case where the initial node 100-2 can receive the response to the existence confirmation signal via the initial portal 123, the initial node 100-2 performs the target portal allocation processing (step S903). After that, the initial node 100-2 ends the restoration processing.

The target portal allocation processing is similar to the processing that has been described with reference to FIG. 6. However, since the target 131 and the target portal 133 have already been determined, only the processing of step S204 is performed.

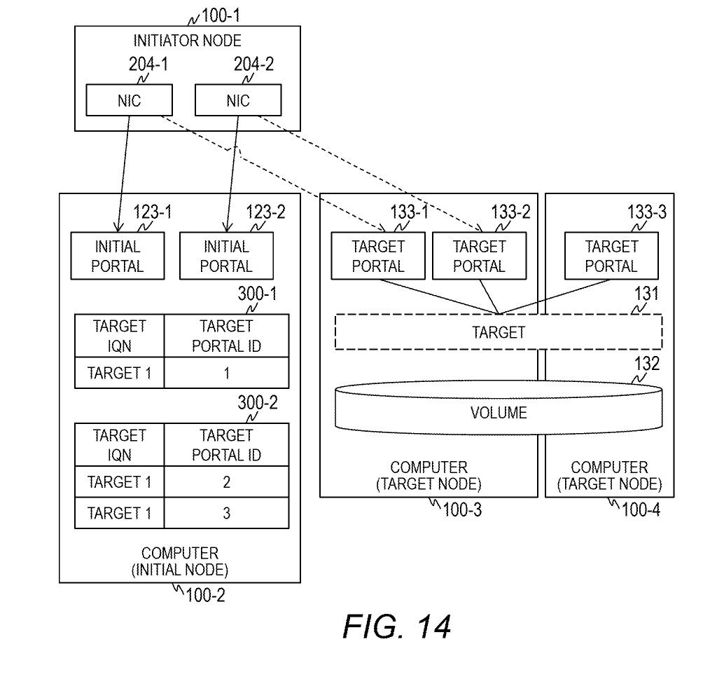

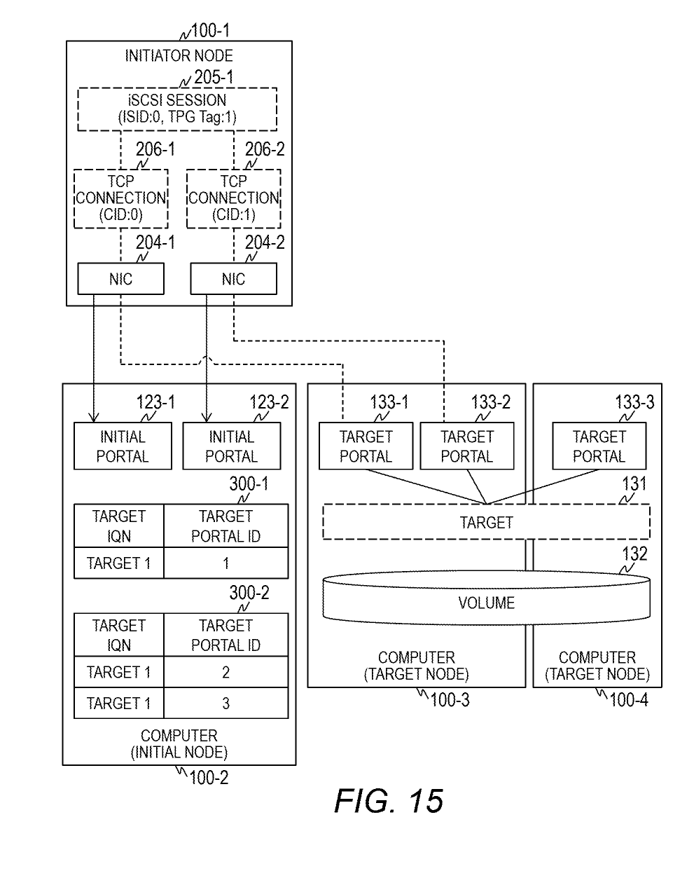

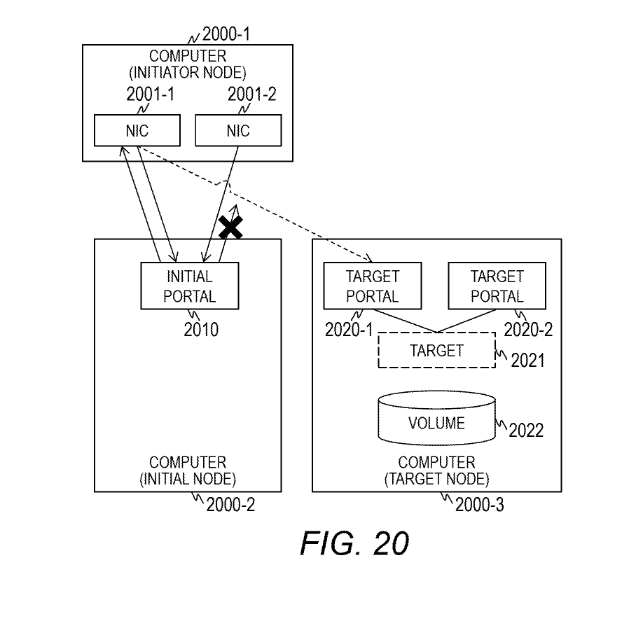

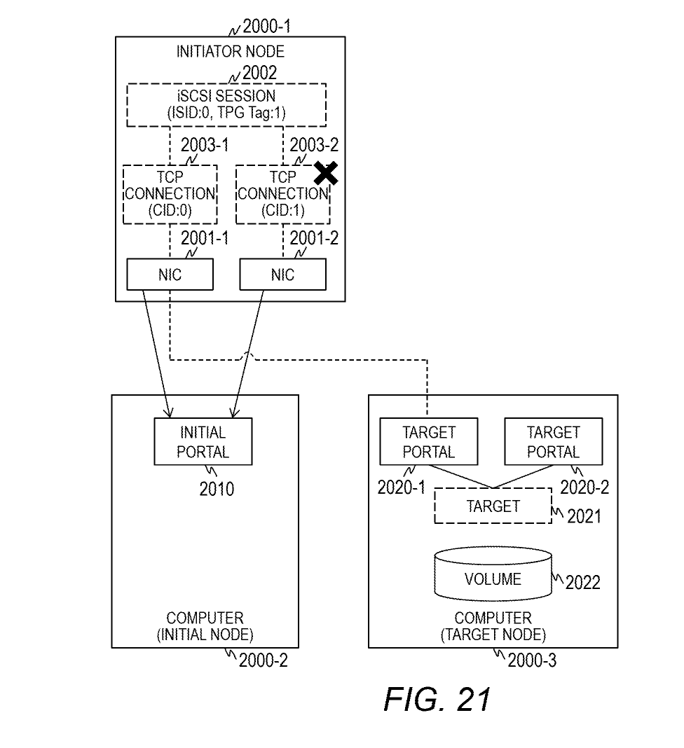

Next, problems of conventional techniques and effects of the present embodiment will be described. FIG. 14 and FIG. 15 are diagrams for explaining effects of the first embodiment. FIG. 20 and FIG. 21 are diagrams for explaining problems of conventional techniques.

(Problem 1)

In order to establish a plurality of paths connecting to the same target by using the log-in redirection function, it is necessary that different target portals 2020-1, 2020-2 are allocated to each of the plurality of NICs 2001-1, 2000-2 included in the initiator node 2000-1. However, establishment of the path via different target portals 2020 is not guaranteed, because the initial node 2000-2 having a conventional log-in redirection function does not manage the path (target) and the notified target portal 2020-1, 2020-2 in association.

As shown in FIG. 20, in a case of receiving the log-in request for establishing the first path connecting to the target 2021, the initial node 2000-2 can process the log-in request normally. That is, the initial node 2000-2 can transmit the log-in response notifying of an arbitrary target portal 2020.

However, the initial node 2000-2 does not recognize the target portal 2020 that has been notified when the first path is established. Thus, in a case of receiving the log-in request for establishing the second path for connecting to the target 2021, the initial node 2000-2 cannot determine an appropriate target portal 2020 that does not duplicate with the first path notified for establishing the second path. Thus, it is not possible to establish a plurality of paths in which interposing of the target portals 2020 that do not duplicate with each other in between the initiator node 2000-1 and the target 2021 is guaranteed.

(Problem 2)

As a method of constructing the multipath, a method of using a function implemented in the iSCSI protocol and a method using the multipath module implemented by an application are known. As a function of implementing by the iSCSI protocol, a multiple connections per session (MC/S) is known. The MC/S makes a plurality of TCP connections to be included in one iSCSI session to establish a plurality of paths in between the initiator node and the target. As the multipath module, a multipath I/O (MPIO) and a linux device mapper are known. The multipath module establishes a plurality of iSCSI sessions in between the initiator node and the target to realize the multipath. When the multipath module is used, TCP connections of the same number as the number of the iSCSI session are generated.

If the MC/S and the log-in redirection function are simply combined, there is a problem as follows.

As shown in FIG. 21, the initiator node 2000-1 transmits, in order to establish the plurality of paths connecting to the target 2021, the log-in request to the initial portal 2010.

Specifically, in order to establish a first path, the initiator node 2000-1 transmits the log-in request via a TCP connection 2003-1 having a CID of “0”. In this case, the log-in is performed normally. In a case of transmitting the log-in request via the TCP connection 2003-2 having the CID of “1” in order to establish a second path, the initiator node 2000-1 transmits the log-in request to the same initial portal 2010. In this case, since the log-in request is the log-in request via the iSCSI session 2002 of the same identification information, the initiator node 2000-1 determines that it is in the log-in state to the target 2021. Thus, when the MC/S and the log-in redirection function are simply combined, the multipath cannot be realized.

The computer system of the first embodiment can solve the (Problem 1) and (Problem 2) described above, as described below.

As shown in FIG. 14, in the computer system of the first embodiment, the plurality of initial portals 123 are set in the initial node 100-2 in accordance with the multiple degree (number of path), and the initiator node 100-1 transmits the log-in request to the different initial portal 123 for each NIC 204. One initial portal 123 is configured so as to process the log-in request for establishing one path, and the target portal 133 is allocated to the initial portal 123 such that the notified target portals for redirection 133 do not duplicate with each other.

According to the configuration described above, the initial node 100-2 can notify the initiator node 100-1, of the target portal for redirection 133 that is different for each path. Thereby, the initiator node 100-1 can transmit the log-in request to the different target portals for redirection 133 in a case where the plurality of paths connecting to the same target 131 are established. Thus, the multipath can be realized by using the log-in redirection function. That is, the (problem 1) can be solved.

As shown in FIG. 15, in the first embodiment, the initiator node 100-1 establishes the TCP connection 206 that is different for each path connecting to the same target 131 to transmit the log-in request to the different initial portal 123. Thus, the (problem 2) can be solved. That is, the multipath in which the MC/S and the log-in redirection function are combined can be realized.

As described above, according to the first embodiment, the multipath can be realized by using the log-in redirection function.

The computer system of the first embodiment can be realized by setting and change of software or the like. That is, it is not necessary to introduce a device for realizing the computer system. Thus, the cost required for introducing of the computer system can be low.

In the present embodiment, the computer system utilizing the iSCSI protocol has been described as an example. However, the present invention can be applied to a system having a function similar to the log-in redirection function.

### Second Embodiment

In the second embodiment, description will be given for processing of in a case where communication failure of a path occurs during operation of the computer system of the first embodiment.

The configuration of the computer system and the configuration of each computer 100 of the second embodiment are the same as those of the first embodiment. The software configurations of the initiator node 100-1, the initial node 100-2, and the target nodes 100-3, 100-4 of the second embodiment are the same as those of the first embodiment.

The initiator management module 110 has a failover function of switching the path in a case where communication failure of a path occurs.

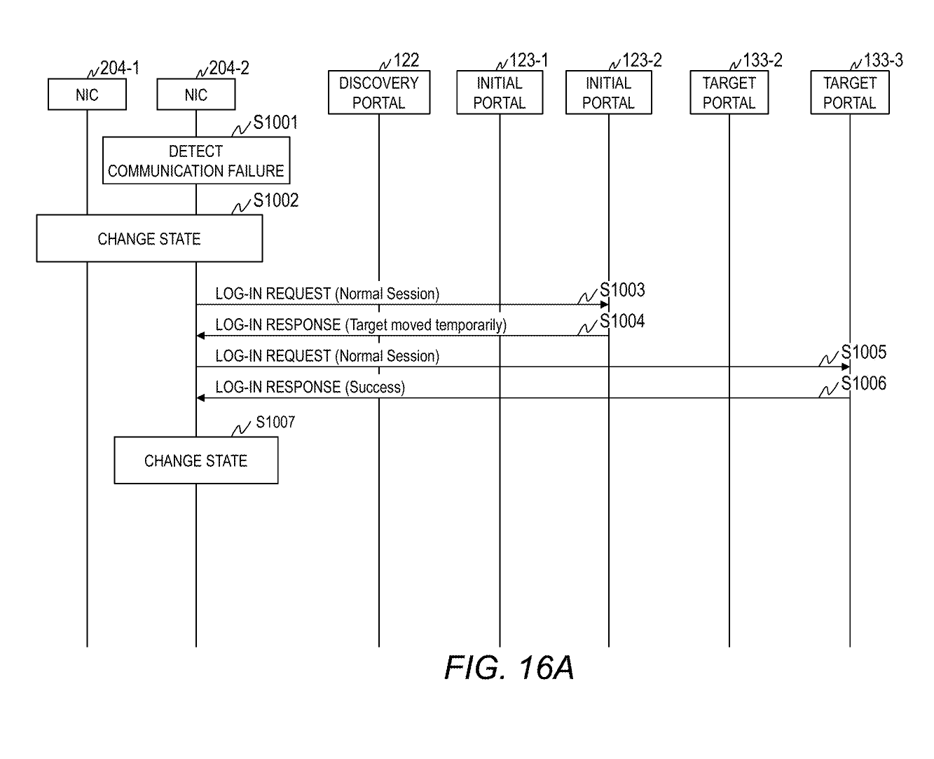

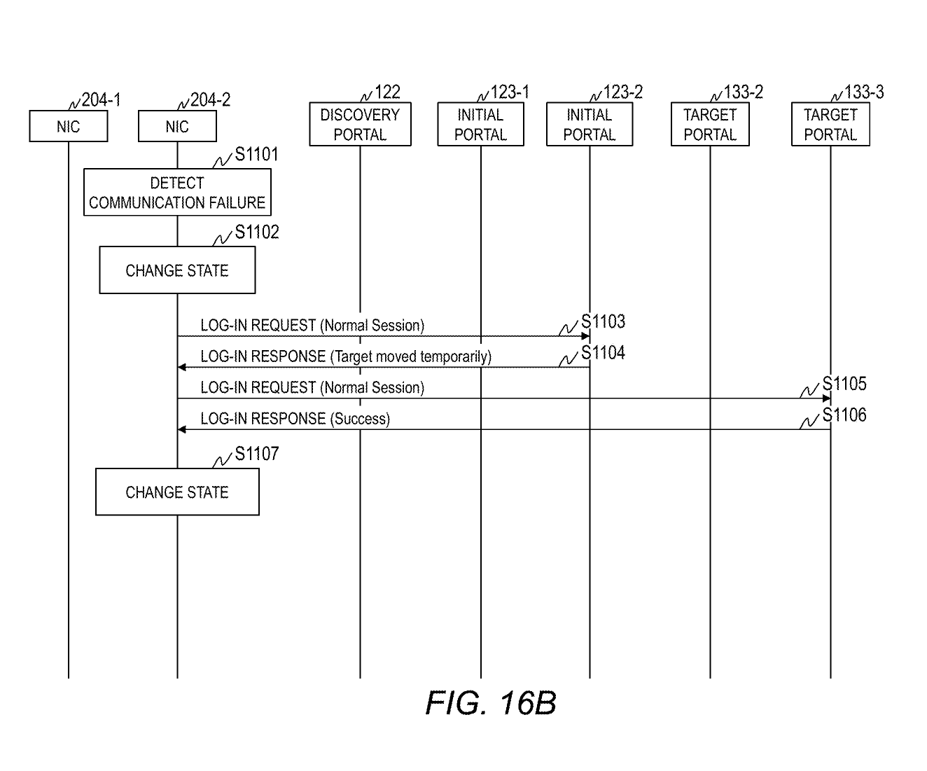

FIG. 16A and FIG. 16B are sequence diagrams for explaining a flow of processing in a case where communication failure of a path occurs in the computer system of the second embodiment.

FIG. 16A shows a flow of processing in a case where communication failure of a path in an active state occurs in a multipath composed of the path in the active state and a path in a standby state. FIG. 16B shows a flow of processing in a case where communication failure of a path in the standby state occurs in a multipath composed of a path in the active state and a path in the standby state or processing in a case where communication failure of a path occurs in a multipath composed of paths all in the active state.

First, description will be given with reference to FIG. 16A for the flow of the processing in a case where communication failure of a path in the active state occurs in a multipath composed of the path in the active state and a path in the standby state. Here, it is assumed that a path established via the NIC 204-1 is in the standby state, and a path established via the NIC 204-2 is in the active state.

The initiator management module 110 detects the communication failure of the path in the active state established via the NIC 204-2 (step S1001).

The initiator management module 110 changes the state of the path (step S1002).

Specifically, the initiator management module 110 changes the state of the path in which the communication failure has been detected, from “active” to “failure”. The initiator management module 110 selects one path in the standby state, and changes the state of the selected path from “standby” to “active”. Thereby, the initiator node 100-1 can access the target 131 by using the path of which the state has been changed to the active state.

The initiator management module 110 transmits the log-in request to the initial portal 123-2 (step S1003).

In a case of receiving the log-in request via the initial portal 123-2, the redirection management module 120 transmits the log-in response notifying of the target portal for redirection 133 to the NIC 204-2 (step S1004). Specifically, processing as below is performed.

The redirection management module 120 refers to the target portal management information 121 to search the target portal 133 to be allocated to the initial portal 123-2. The redirection management module 120 transmits the existence confirmation signal to the searched target portal 133, and specifies the target portal 133 that has responded.

In the present embodiment, the target portals 133-2, 133-3 are allocated to the initial portal 123-2, and since the communication failure of the path established via the target portal for redirection 133-2 has occurred, the redirection management module 120 receives a response from the target portal 133-3.

The redirection management module 120 selects the target portal 133-3 from among the specified target portal 133 as the target portal for redirection 133. The redirection management module 120 transmits the log-in response notifying the selected target portal for redirection 133-3 to the NIC 204-2 via the initial portal 123-2.

Note that the redirection management module 120 may not perform existence confirmation of the target portal 133. In this case, the redirection management module 120 selects a target portal other than the target portal 133 that has been notified for establishing the path in which failure has occurred, from among the specified target portals 133. The processing of step S104 is as described above.

In a case of receiving the log-in response via the NIC 204-2, the initiator management module 110 transmits the log-in request to the notified target portal for redirection 133-3 (step S1005).

In a case of receiving the log-in request via the target portal for redirection 133-3, the target node 100-4 transmits the log-in response notifying that the log-in is successful to the NIC 204-2 via the target portal for redirection 133-3 (step S1006). Thereby, a path is established in between the initiator node 100-1 and the target 131. That is, the path is restored.

In a case of receiving the log-in response via the NIC 204-2, the initiator management module 110 changes the state of the restored path (step S1007).

Note that the state of the restored path can be set to an arbitrary state. Specifically, the initiator management module 110 changes the state of the restored path from “failure” to “active” or “standby”. The method of changing the state is determined on the basis of control policy of the system.

In this way, after the path to be used is switched, the restoration of the path using the log-in redirection function is performed, so that the connection with the target 131 and the multiple degree of the path can be maintained.

Next, description will be given with reference to FIG. 16B for a flow of processing in a case where the path established via the NIC 204-1 is in the active state, and the path established via the NIC 204-2 is in the standby state.

The initiator management module 110 detects the communication failure of the path in the standby state established via the NIC 204-2 (step S1101).

The initiator management module 110 changes the state of the path (step S1102).

Specifically, the initiator management module 110 changes the state of the path in which the communication failure has been detected from “standby” to “failure.” In this case, the path to be used is not switched.

The initiator management module 110 transmits the log-in request to the initial portal 123-2 (step S1103). The processing of step S1103 is the same processing as the processing of step S1003.

In a case of receiving the log-in request via the initial portal 123-2, the redirection management module 120 transmits the log-in response notifying of the target portal for redirection 133 to the NIC 204-2 (step S1104). The processing of step S1104 is the same as the processing of step S1004.

In a case of receiving the notification of the target portal for redirection 133-3 via the NIC 204-2, the initiator management module 110 transmits the log-in request to the target portal for redirection 133-3 (step S1105). The processing of step S1105 is the same as the processing of step S1005.

In a case of receiving the log-in request via the target portal 133-3, the target node 100-3 transmits the log-in response notifying that the log-in is successful to the NIC 204-2 via the target portal 133-3 (step S1106). The processing of step S1106 is the same as the processing of step S1006.

In a case of receiving the log-in response via the NIC 204-2, the initiator management module 110 changes the state of the restored path (step S1107). Specifically, the initiator management module 110 changes the state of the path from “failure” to “standby”.

Next, description will be given with reference to FIG. 16B for the flow of the processing of when the path established via the NIC 204-1 and the path established via the NIC 204-2 are in the active state.

In this case, the processing of step S1102 and step S1107 is different. Specifically, in step S1102, the initiator management module 110 changes the state of the path from “active” to “failure”. In step S1107, the initiator management module 110 changes the state of the path from “failure” to “active”.

According to the second embodiment, while utilizing the log-in redirection function, the multiple degree of the path can be maintained.

### Third Embodiment

Description will be given for the computer system that realizes the multipath by using the log-in redirection function in a different method from the first embodiment. Description will be given below for the third embodiment, mainly for the difference from the first embodiment.

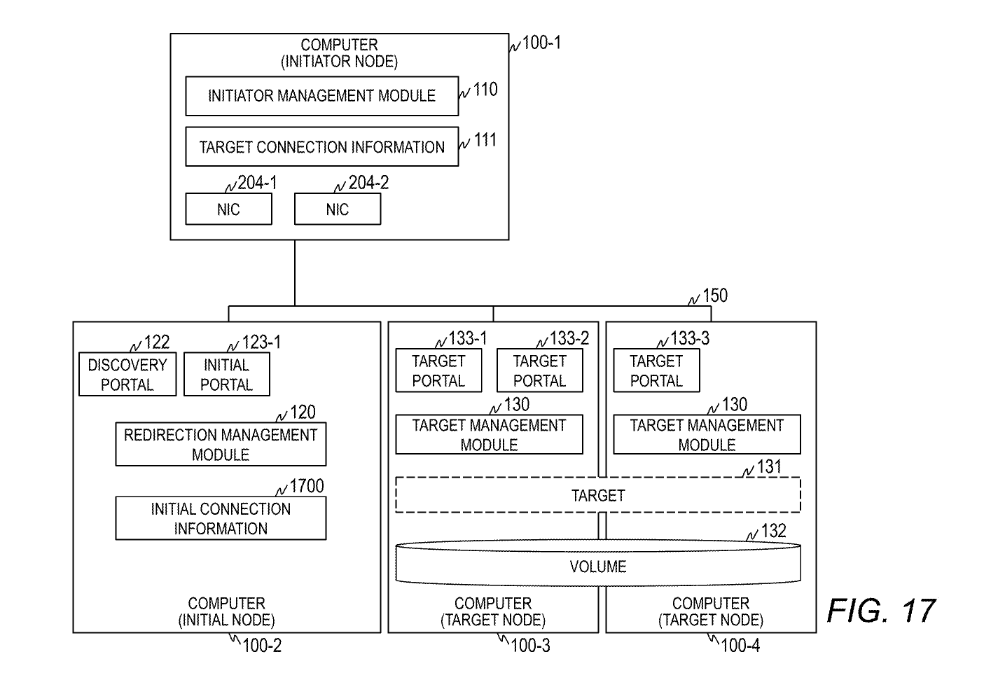

FIG. 17 is a diagram showing a configuration example of the computer system that realizes the connection using the iSCSI protocol of the third embodiment.

The device configuration of the computer system of the third embodiment is the same as that of the first embodiment. Only one initial portal 123-1 is set in the initial node 100-2 of the third embodiment. The initial node 100-2 of the third embodiment holds the initial connection information 1700, instead of the target portal management information 121. Although not shown in the drawing, the initial node 100-2 also holds information in which the identification information and the connection information of the target portal 133 are associated with each other.

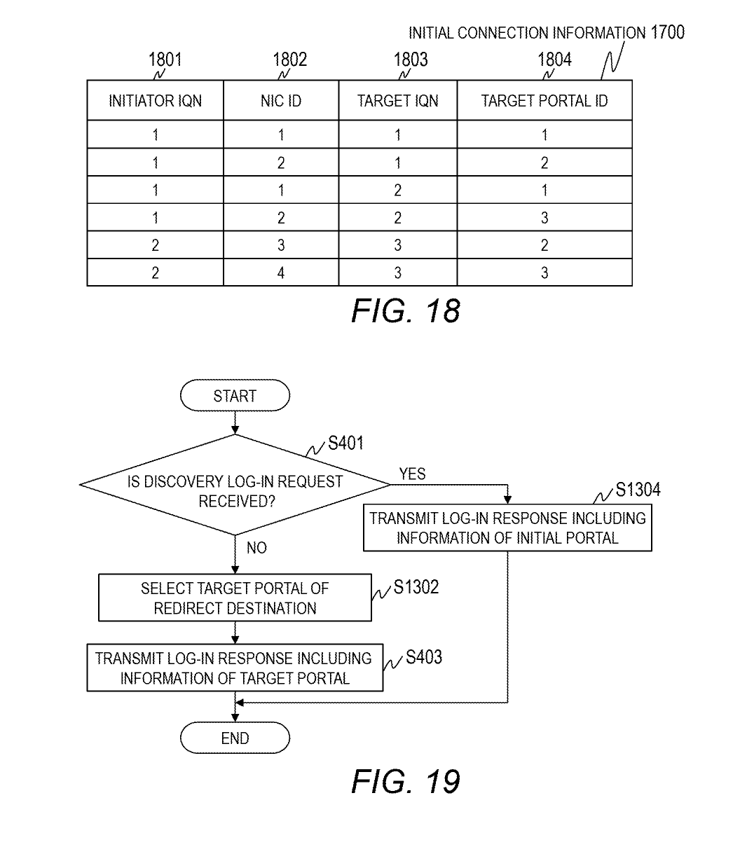

The initial connection information 1700 is information for managing the target portal for redirection 133 that has been notified to the initiator node 100-1. More specifically, the initial connection information 1700 is information for managing the correspondence relationship of the NIC 204 of the initiator node 100-1, the target 131, and the target portal for redirection 133 that have been used for establishment of the path. Details of the initial connection information 1700 will be described with reference to FIG. 18.

The identification information of the initial portal 123-1 is set in the initial portal ID 302 of the entry included in the target connection information 111 of the third embodiment.

FIG. 18 is a diagram showing an example of the data structure of the initial connection information 1700 of the third embodiment.

The initial connection information 1700 includes the entry formed of an initiator IQN 1801, a NIC ID 1802, a target IQN 1803, and a target portal ID 1804.

The initiator IQN 1801 is a field storing the IQN that is the identification information of the initiator node 100-1. The NIC ID 1802 is a field storing the identification information of the NIC 204 included in the initiator node 100-1.

The target IQN 1803 is the same field as the target IQN 401. The target portal ID 1804 is a field that stores the identification information of the target portal for redirection 133.

The flow of the processing of establishing the path is the same as the flow of the processing shown in FIG. 7. However, in the third embodiment, in the log-in processing, part of the processing performed by the initial node 100-2 is different.

FIG. 19 is a flowchart for explaining an example of processing performed by the initial node 100-2 of the third embodiment in a case of receiving the log-in request.

In step S401, in a case where it is determined that the log-in request that has been received is not the discovery log-in request, the redirection management module 120 selects the target portal for redirection 133 to be notified to the initial node 100-2 on the basis of the initial connection information 1700 (step S1302). Specifically, the processing as below is performed.

The redirection management module 120 obtains the IQN of the initiator node 100-1, the identification information of the NIC 204, and the IQN of the target 131 from the log-in request.

The redirection management module 120 refers to the initial connection information 1700 to search the entry having combination of values of the initiator IQN 1801, the NIC ID 1802, and the target IQN 1803 that coincides with combination of values acquired from the log-in request.

In a case where there is no entry corresponding to the initial connection information 1700, the redirection management module 120 adds an entry to the initial connection information 1700, and sets a value included in the log-in request to each of the initiator IQN 1801, the NIC ID 1802, and the target IQN 1803 of the added entry. The redirection management module 120 selects the target portal for redirection 133 from among the target portals 133. The redirection management module 120 sets the identification information of the selected target portal for redirection 133 to the target portal ID 1804 of the added entry.

In a case where there is the entry corresponding to the initial connection information 1700, the redirection management module 120 selects the target portal 133 different from the target portal for redirection 133 that has been used for establishment of the other path, from among the target portals 133. The redirection management module 120 overwrites the identification information of the selected target portal for redirection 133 to the target portal ID 1804 of the searched entry.

Note that the present invention is not limited to the selection method of the target portal for redirection 133. As the selection method of the target portal for redirection 133, a similar method to that of the first embodiment is conceived. In addition, selection methods of (5) and (6) as below are conceived.

(5) The redirection management module 120 selects the target portal 133 different from the target portal for redirection 133 that has been notified in the previous time as the target portal for redirection 133. In the case of this method, it is not necessary to confirm the existence of the target portal 133 in a case where the re-log-in processing along with the occurrence of communication failure is performed. Thus, the path can be restored quickly.

(6) The redirection management module 120 selects the target portal for redirection 133 that has been notified in the previous time. In this method, in order to cope with the re-log-in processing along with the occurrence of communication failure, it is necessary to confirm the existence of the target portal 133 to be allocated, before the selection of the target portal for redirection 133. In a case where the existence has been confirmed, the redirection management module 120 selects the target portal 133 that is the same as that in the previous time as the target portal for redirection 133. In a case where the existence has not been confirmed, the redirection management module 120 selects the target portal different from that in the previous time as the target portal for redirection 133. When this method is adopted, an effect can be obtained, that certain I/O performance can be maintained.

Description of the processing of step S1302 is as above.

In step S403, the redirection management module 120 transmits the log-in response notifying the selected target portal for redirection 133 to the initiator node 100-1 via the initial portal 123-1.

In step S401, in a case where it is determined that the received log-in request is the discovery log-in request, the redirection management module 120 transmits the discovery log-in response including the information of the initial portal 123-1 to the initiator node 100-1 via the discovery portal 122 (step S1304).

Note that, when the MC/S is adopted, the (problem 2) cannot be solved by the system of the third embodiment. Thus, the configuration of the third embodiment can be applied to the computer system in which the multipath module is adopted. However, as similar to the first embodiment, a plurality of initial portals 123 are set, and the initial portal 123 of the transmission destination of the log-in request is divided, so that the configuration can cope with the computer system in which the MC/S is adopted.

The processing of when the target portal 133 is deleted or added is a similar processing to that of the first embodiment. However, in the third embodiment, the initial connection information 1700 is a target to be updated. The processing of when communication failure of a path occurs is a similar processing to that of the first embodiment.

According to the third embodiment, a similar effect to that of the first embodiment can be exhibited.

The present invention is not limited to the above embodiment and includes various modification examples. In addition, for example, the configurations of the above embodiment are described in detail so as to describe the present invention comprehensibly. The present invention is not necessarily limited to the embodiment that is provided with all of the configurations described. In addition, a part of each configuration of the embodiment may be removed, substituted, or added to other configurations.

A part or the entirety of each of the above configurations, functions, processing units, processing means, and the like may be realized by hardware, such as by designing integrated circuits therefor. In addition, the present invention can be realized by program codes of software that realizes the functions of the embodiment. In this case, a storage medium on which the program codes are recorded is provided to a computer, and a CPU that the computer is provided with reads the program codes stored on the storage medium. In this case, the program codes read from the storage medium realize the functions of the above embodiment, and the program codes and the storage medium storing the program codes constitute the present invention. Examples of such a storage medium used for supplying program codes include a flexible disk, a CD-ROM, a DVD-ROM, a hard disk, a solid state drive (SSD), an optical disc, a magneto-optical disc, a CD-R, a magnetic tape, a non-volatile memory card, and a ROM.

The program codes that realize the functions written in the present embodiment can be implemented by a wide range of programming and scripting languages such as assembler, C/C++, Perl, shell scripts, PHP, and Java (registered trademark).

It may also be possible that the program codes of the software that realizes the functions of the embodiment are stored on storing means such as a hard disk or a memory of the computer or on a storage medium such as a CD-RW or a CD-R by distributing the program codes through a network and that the CPU that the computer is provided with reads and executes the program codes stored on the storing means or on the storage medium.

In the above embodiment, only control lines and information lines that are considered as necessary for description are illustrated, and all the control lines and information lines of a product are not necessarily illustrated. All of the configurations of the embodiment may be connected to each other.

What is claimed is:

1. A computer system comprising a plurality of computers, wherein
the plurality of computers has at least one arithmetic device, at least one storage device coupled to the at least one arithmetic device, and a plurality of communication devices coupled to the at least one arithmetic device,
the plurality of computers includes:
a first computer having a first processing unit configured to perform processing by using a storage region;
a second computer having a second processing unit configured to provide the storage region, manage a first port for communication with the first processing unit, and execute a processing request to the storage region that has been received via the first port; and
a third computer having a third processing unit configured to manage a second port for communication with the first processing unit, and notify the first computer of the first port for redirecting serving as a redirect destination of a connection request for establishment of a communication path connecting the first processing unit and the second processing unit in a case of receiving the connection request via the second port,
the third processing unit holds port management information for managing a correspondence relationship of the first port and the second port,
the first processing unit is configured to:
transmit the connection request to the second port in a case of establishing the communication path;
receive a response notifying the first port for redirecting from the third processing unit; and
transmit the connection request to the first port for redirecting to establish the communication path, and
the third processing unit is configured to:
select the first port for redirecting on the basis of the port management information in a case of receiving the connection request; and
transmit the response notifying the first port for redirecting to the first processing unit.

2. The computer system according to claim 1, wherein
a plurality of the second ports are set in the third computer,
the first processing unit holds connection information for managing a correspondence relationship of the plurality of the second ports and the plurality of communication devices included in the first computer,
the port management information is information for managing a plurality of the first ports allocated to each of the plurality of the second ports,
the first processing unit is configured to:
select the second port on the basis of the connection information in a case of establishing the communication path; and
transmit the connection request to the selected second port, and
the third processing unit is configured to:
specify at least of the first port allocated to the second port that have been used for transmission of the processing request, on the basis of the port management information in a case of receiving the connection request; and
select the first port for redirecting from among the at least one of the first port that has been specified.

3. The computer system according to claim 2, wherein
the third processing unit is configured to:
allocate the plurality of the first ports to each of the plurality of the second ports without duplicating; and
register a result of the allocation to the port management information.

4. The computer system according to claim 3, wherein
the second processing unit is configured to transmit addition notification including information of a new first port to the third processing unit in a case where the new first port is added, and
the third processing unit is configured to:
allocate the new first port to any of the plurality of the second ports; and
register a result of allocation of the new first port to the port management information.

5. The computer system according to claim 3, wherein
the second processing unit is configured to:
transmit a deletion schedule notification for notifying the first port to be deleted to the third processing unit;
receive an update completion notification of the port management information from the third processing unit; and
perform disconnecting processing of a communication path established by using the first port to be deleted as the first port for redirecting, and
the third processing unit is configured to:
receive the deletion schedule notification of the first port to be deleted; and
delete information associated with the first port to be deleted from the port management information and transmit the update completion notification of the port management information to the second processing unit.

6. The computer system according to claim 3, wherein
the first processing unit is configured to:
transmit, in a case of detecting failure of the communication path, the connection request to a second port that has been used for establishment of the communication path where failure occurred; and
transmit the connection request to a new first port for redirecting included in a response that has been received from the third processing unit to establish a communication path, and
the third processing unit is configured to:
specify at least one of the first port allocated to the second port that has been used for transmission of the connection request, on the basis of the port management information in a case of receiving the connection request; and
select the new first port for redirecting from among the at least of the first port that has been specified, and can perform communication.

7. The computer system according to claim 1, wherein
the port management information is information for managing a correspondence relationship between connection information that has been used in a case where the first processing unit establishes the communication path, and information of the first port for redirecting that has been notified to the first processing unit, and
the third processing unit is configured to:
specify at least one of the first port different from the first port that has been used for connection of another communication path, on the basis of the port management information in a case of receiving the connection request; and
select the first port for redirecting from among the at least one of the first port that has been specified.

8. A control method for a communication path of a computer system including a plurality of computers, wherein
the plurality of computers having at least one arithmetic device, at least one storage device coupled to the at least one arithmetic device, and a plurality of communication devices coupled to the at least one arithmetic device,
the plurality of computers includes:
a first computer having a first processing unit configured to use a storage region to perform processing;
a second computer having a second processing unit configured to provide the storage region, manage a first port for communication with the first processing unit, and process a processing request to the storage region that has been accepted via the first port; and
a third computer having a third processing unit configured to manage a second port for communication with the first processing unit, and notify the first computer, of the first port for redirecting serving as a redirect destination of the connection request in a case of receiving the connection request for establishment of a communication path connecting the first processing unit and the second processing unit via the second port,
the third processing unit holds port management information for managing a correspondence relationship of the first port and the second port, and
the control method of the communication path includes:
a first step of transmitting, by the first processing unit, the connection request to the second port;
a second step of selecting, by the third processing unit, the first port for redirecting on the basis of the port management information in a case of receiving the connection request, and transmitting a response for notifying of the first port for redirecting to the first processing unit; and
a third step of receiving, by the first processing unit, a response for notifying the first port for redirecting from the third processing unit and transmitting the connection request to the first port for redirecting to establish the communication path.

9. The control method for a communication path according to claim 8, wherein
a plurality of the second ports are set in the third computer,
the first processing unit holds connection information for managing a correspondence relationship of the plurality of the second ports and the plurality of communication devices included in the first computer,
the port management information is information for managing a plurality of the first ports allocated to each of the plurality of the second ports,
the first step includes:
a step of selecting, by the first processing unit, the second port on the basis of the connection information; and
a step of transmitting, by the first processing unit, the connection request to the second port that has been selected, and
the second step includes:
a step of specifying, by the third processing unit, at least one of the first port allocated to the second port that has been used for transmission of the processing request, on the basis of the port management information; and
a step of selecting, by the third processing unit, the first port for redirecting from among the at least one of the first port that has been specified.

10. The control method for a communication path according to claim 9, further including:
a step of allocating, by the third processing unit, the plurality of the first ports to each of the plurality of the second ports without duplicating; and
a step of registering, by the third processing unit, a result of the allocation in the port management information.

11. The control method for a communication path according to claim 10, further including:
a step of transmitting, by the second processing unit, addition notification including information of a new first port to the third processing unit in a case where the new first port is added;
a step of allocating, by the third processing unit, the new first port to any of the plurality of the second ports; and
a step of registering, by the third processing unit, a result of allocation of the new first port in the port management information.

12. The control method for a communication path according to claim 10, further including:
a step of transmitting, by the second processing unit, a deletion schedule notification for notifying of the first port to be deleted to the third processing unit;
a step of receiving, by the third processing unit, the deletion schedule notification of the first port to be deleted, and deleting information associated with the first port to be deleted from the port management information;
a step of transmitting, by the third processing unit, an update completion notification of the port management information to the second processing unit; and
a step of receiving, by the second processing unit, the update completion notification of the port management information from the third processing unit, and performing disconnection processing of a communication path established by using the first port to be deleted as the first port for redirecting.

13. The control method for a communication path according to claim 10, further including:
a step of transmitting, by the first processing unit, in a case of detecting failure of the communication path, the connection request to a second port that has been used for establishment of the communication path where failure occurred;
a step of specifying, by the third processing unit, at least one of the first port allocated to the second port that has been used for transmission of the connection request, on the basis of the port management information in a case of receiving the connection request, and selecting a new first port for redirecting from among the at least one of the first port that has been specified, and can perform communication;
a step of transmitting, by the third processing unit, a response for notifying the first processing unit, of the new first port for redirecting; and
a step of transmitting, by the first processing unit, the connection request to the new first port for redirecting to establish the communication path.

14. The control method for a communication path according to claim 8, wherein
the port management information is information for managing a correspondence relationship between connection information that has been used in a case where the first processing unit establishes the communication path, and information of the first port for redirecting that has been notified to the first processing unit, and
the second step includes:
a step of specifying, by the third processing unit, at least one of the first port different from the first port that has been used for connection of another communication path, on the basis of the port management information in a case of receiving the connection request; and
a step of selecting, by the third processing unit, the first port for redirecting from among the at least one of the first port that has been specified.
